(19) United States
(12) Patent Application Publication
(10) Pub. No.: US 2015/0006384 A1
(43) Pub. Date: Jan. 1, 2015

(54) DEVICE FINGERPRINTING

(71) Applicant: Zahid Nasiruddin Shaikh, Timonium, MD (US)

(72) Inventor: Zahid Nasiruddin Shaikh, Timonium, MD (US)

(21) Appl. No.: 13/931,617

(22) Filed: Jun. 28, 2013

(51) Int. Cl. G06Q 20/40

(52) U.S. Cl. CPC G06Q 20/4016
USPC 705/44

(57) ABSTRACT

Systems and methods for detecting fraud are described. The methods include collecting identifying information regarding a user device, creating a device identifier (ID) based on the identifying information, generating a session key that is associated with a transaction, associating the session key with the device ID, storing the session key with the device ID, receiving the session key from a merchant, retrieving the device ID, determining a number of users associated with the device ID, and based on the number, assessing a risk of fraud for the transaction.

### BACKGROUND

1. Field of the Invention

The invention is directed towards identifying and preventing fraud in transactions over the Internet.

2. Related Art

The continued growth of telecommunications infrastructure and proliferation of network devices, service providers, wireless technology and related software products have transformed the Internet into a tool for everyday use. Businesses are increasingly using the Internet as a method of communicating with customers, vendors, employees and shareholders and conducting business transactions. In theory, conducting business on the Internet is often efficient and cost effective, particularly when products and services can be distributed electronically. In practice, damage caused by hackers, identity theft, stolen credit cards, and other fraudulent activities can be enormously expensive and difficult to manage. Thus, a need exists for systems and methods that provide increased security for transactions performed on the Internet.

### BRIEF DESCRIPTION OF THE FIGURES

FIG. 1 is a flowchart showing a method for detecting fraud according to an embodiment of the present disclosure;

FIG. 2 is a block diagram of a networked system suitable for detecting fraud according to an embodiment of the present disclosure; and

FIG. 3 is a block diagram of a computer system suitable for implementing one or more components in FIG. 2 according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods of creating a device fingerprint from available data in a web session. This data is used to identify individual users by identifying the device used by the user. When a user goes onto a webpage that has integrated fraud components controlled by a service provider, such as PayPal®, Inc. of San Jose, Calif., the service provider runs JavaScript contained within the page to create a device fingerprint. For example, when a user applies for credit or another service on PayPal®'s Bill Me Later® webpage, data is collected from the user device when the user lands on the page and conducts a specific transaction. The device fingerprint is stored in a database and associated with the specific transaction through use of a session key. Super cookies (or other information that is secured against alteration) can be used to fingerprint user devices. The session key is passed to the service provider, which uses the device fingerprint to determine the number of users associated with the device fingerprint and assesses the risk of fraud.

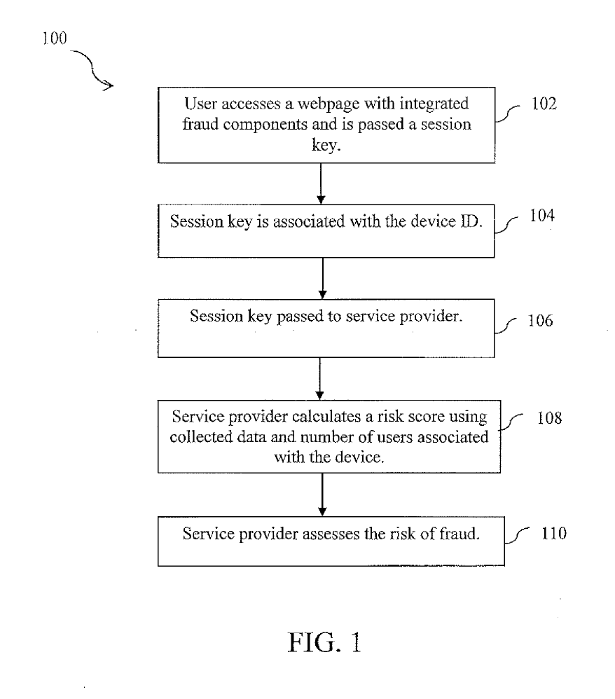

The systems and methods described herein facilitate the detection of fraud and prevent identity theft and transaction fraud. Referring now to FIG. 1, a flowchart of a method 100 for detecting fraud is illustrated according to an embodiment of the present disclosure. In an embodiment, at step 102, a user accesses a webpage that has integrated fraud components and is passed a session key by the webpage. The session key is a unique number associated with a specific transaction or purchase of the user. The specific transaction includes details such as purchase amount, transfer amount, type of transfer requested, item or service purchased, etc. In some embodiments, the session key is an order number.

The webpage may be a merchant webpage, and JavaScript may simply be downloaded to the webpage to enable the functionality of the fraud components and the session key. In one embodiment, the JavaScript is run by a service provider, such as PayPal®, Inc. of San Jose, Calif.

Once the user lands on the webpage, he or she may start shopping as JavaScript collects identifying information regarding the user device. The user device may be implemented as a personal computer (PC), a smart phone, personal digital assistant (PDA), laptop computer, and/or other types of computing devices capable of transmitting and/or receiving data. Identifying information of the user device includes information related to characteristics of the user device such as an IP address, a local time, a local time zone, a browser user-agent, a font type, a microprocessor type, a screen size, a microprocessor processing characteristic, a microprocessor serial number network address, a network connection speed, a network rate for data upload to the server, plugin version information, or a network rate for data download from the server. Data collected on the server side can include a fraud beacon session ID (a 32-character generated universally unique identifier (QUID) that is generated each time the application is loaded), IP address, browser user-agent, referer (header indicating the referring page), HTTP accept header, HTTP accept-language header, HTTP accept-encoding header, HTTP accept-charset header (accept character set header), HTTP DNT header (“do not track” option), and visitor ID. Data collected on the client side can include data on whether JavaScript or cookies are enabled, flash version numbers, flash visitor ID, browser language, JavaScript navigator structure contained information (appCodeName, appName, appVersion, buildID, onLine, ospcu, platform, product, and productSub), browser user-agent string, vendor, vendorSub, color depth/pixel depth, height and width of screen, fonts, and plugins.

In some embodiments, the service provider creates a device fingerprint or identifier (ID) based on the identifying information and causes the device ID to be stored on the user device as persistent data, e.g., cookies. In various embodiments, the JavaScript passes super cookies to the user device. The device fingerprint or ID uniquely identifies the user device.

At step 104, the session key is associated with the device ID, and both are stored in a database of the service provider.

At step 106, when the user is ready to make the purchase, the merchant website passes the session key to the service provider. The service provider retrieves the session key from its database, along with the associated device ID. The service provider searches for the device information in its records and identifies the users associated with the device.

At step 108, the service provider calculates a risk score using the collected data (i.e., identifying information regarding the user device or device ID) and the number of users associated with the device. The risk score indicates the likelihood or probability that the user is a fraudster. The risk score may be a numerical value (e.g., 0.2 out of a range of values between 0 and 1, where 1 indicates that the user has committed identity theft) or may be a qualitative description (e.g., “very risky,” “slightly risky,” or “not risky”). For example, if the device ID is associated with a single user, the risk score assigned to the transaction may be “not risky.” If the device ID, however, is associated with more than two users (e.g., 3-10 users), the risk score assigned may be “very risky.” As the number of users associated with the user device increases, the likelihood of fraud also increases.

In some embodiments, a determination of whether the number of users exceeds or crosses a predetermined number is made. The predetermined number may be associated with the level of certainty that the user is or is not a fraudster. If the number of users exceeds the predetermined number, the user may be determined to be a fraudster. For example, if the number of users does not exceed a predetermined number, the user may be determined to be an authentic user. In other embodiments, if the number of users far exceeds a predetermined number, the user may be determined to be a fraudster.

While the number of users may be sufficient to determine the risk score, more information may be used to determine with increasing probability that the user is or is not a fraudster. In some embodiments, other information may be combined with the number of users associated with a user device to provide a greater degree of certainty that the user is a fraudster or that he or she is authentic. Such information may include, for example, the number of times the user has made a purchase from the user device and how recently the purchase was made.

At step 110, the service provider assesses the risk of fraud for the transaction. In the case where the risk score is “not risky,” the service provider allows the transaction to be processed. Where the risk score is “very risky,” the service provider may reject the transaction or the scope of the transaction may be limited. In certain embodiments, if the number of users associated with the device ID exceeds a predetermined number (e.g., more than two), the transaction may be automatically rejected or the scope of the transaction limited.

In one embodiment, the risk score for the transaction is used to determine the scope of transactions that can be performed by the user 102. For example, if the risk score assigned to the transaction is “very risky,” transactions that carry a high degree of risk (e.g., a high dollar amount, luxury goods, etc.) may be prohibited. On the other hand, transactions that carry a lower degree of risk (e.g., low dollar amounts) may be allowed.

In various embodiments, the service provider server receives financial transaction information when the user attempts to use his or her financial account with the service provider. The transaction information may include information about the seller such as the seller's contact information, namely email address, user name, mailing address, as well as the seller's specified financial account. The transaction information may also include information about the buyer, e.g., the user, such as the buyer's billing and shipping address information, the buyer's telephone number(s), the buyer's email address, the buyer's user name, and the financial account the buyer has selected to use to pay for the transaction. In addition, the transaction information may include the price of the good(s) and/or service(s) and a description of the good(s) and/or service(s).

The service provider may look at the risk score assigned to the transaction and determine whether or not to process the transaction. The service provider may completely block the transaction in some instances. In some embodiments, the service provider examines the transaction and anticipates the severity of possible fraud. Each type of transaction may be assigned a severity in accordance with the risk it poses. The severity level may be based on, for example, how much time would need to be spent to remediate fraud, how much money would potentially be lost, and/or how badly the credit worthiness of the actual user would be damaged. A severity may be assigned to the transaction, and the decision on whether or not to process the transaction may further depend on the assigned severity. High, moderate, or low risk transactions may be subject to further analysis.

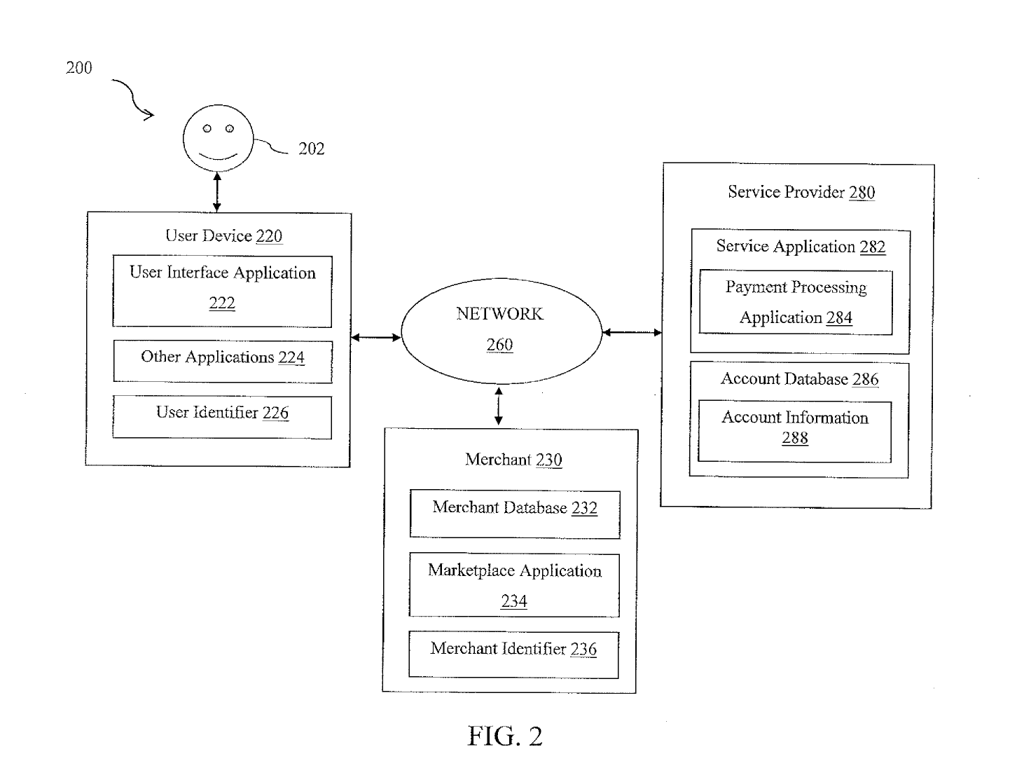

FIG. 2 shows one embodiment of a block diagram of a network-based system 200 adapted to detect fraud of a user 202 using a user device 220 over a network 260. As shown, system 200 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 2 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 2, the system 200 includes a user device 220 (e.g., smartphone), one or more merchant servers or devices 230 (e.g., network server devices), and at least one service provider server or device 280 (e.g., network server device) in communication over the network 260. In various examples, user device 220 may be implemented as a wireless telephone (e.g., cellular or mobile phone), a tablet, a personal digital assistant (PDA), a personal computer, a notebook computer, and/or various other generally known types of wired and/or wireless computing devices.

The network 260, in one embodiment, may be implemented as a single network or a combination of multiple networks. For example, in various embodiments, the network 260 may include the Internet and/or one or more intranets, landline networks, wireless networks, and/or other appropriate types of communication networks. In another example, the network 260 may comprise a wireless telecommunications network (e.g., cellular phone network) adapted to communicate with other communication networks, such as the Internet. As such, in various embodiments, the user device 220, merchant servers or devices 230, and service provider server or device 280 may be associated with a particular link (e.g., a link, such as a URL (Uniform Resource Locator) to an IP (Internet Protocol) address).

The user device 220, in various embodiments, may be implemented using any appropriate combination of hardware and/or software configured for wired and/or wireless communication over the network 260. The user device 220, in one embodiment, may be utilized by the user 202 to interact with the service provider server 280 over the network 260. For example, the user 202 may conduct financial transactions (e.g., account transfers) with the service provider server 280 via the user device 220.

The user device 220, in one embodiment, includes a user interface application 222, which may be utilized by the user 202 to conduct transactions (e.g., shopping, purchasing, bidding, etc.) with the merchant server or device 230 or with the service provider server 280 over the network 260. In one aspect, purchase expenses may be directly and/or automatically debited from an account related to the user 202 via the user interface application 222.

In one implementation, the user interface application 222 comprises a software program, such as a graphical user interface (GUI), executable by a processor that is configured to interface and communicate with the service provider server 280 via the network 260. In another implementation, the user interface application 222 comprises a browser module that provides a network interface to browse information available over the network 260. For example, the user interface application 222 may be implemented, in part, as a web browser to view information available over the network 260.

In an example, the user 202 is able to access merchant websites via the one or more merchant servers 230 to view and select items for purchase, and the user 202 is able to purchase items from the one or more merchant servers 230 via the service provider server 280. Accordingly, in one or more embodiments, the user 202 may conduct transactions (e.g., purchase and provide payment for one or more items) from the one or more merchant servers 230 via the service provider server 280.

The user device 220, in various embodiments, may include other applications 224 as may be desired in one or more embodiments of the present disclosure to provide additional features available to user 202. In one example, such other applications 224 may include security applications for implementing client-side security features, programmatic client applications for interfacing with appropriate application programming interfaces (APIs) over the network 260, and/or various other types of generally known programs and/or software applications. In still other examples, the other applications 224 may interface with the user interface application 222 for improved efficiency and convenience.

The user device 220, in one embodiment, may include at least one user identifier 226, which may be implemented, for example, as operating system registry entries, cookies associated with the user interface application 222, identifiers associated with hardware of the user device 220, or various other appropriate identifiers. The user identifier 226 may include one or more attributes related to the user 202, such as personal information related to the user 202 (e.g., one or more user names, passwords, photograph images, biometric IDs, addresses, phone numbers, etc.) and banking information and/or funding sources (e.g., one or more banking institutions, credit card issuers, user account numbers, security data and information, etc.). In various implementations, the user identifier 226 may be passed with a user login request to the service provider server 280 via the network 260, and the user identifier 226 may be used by the service provider server 280 to associate the user 202 with a particular user account maintained by the service provider server 180.

The one or more merchant servers 230, in various embodiments, may be maintained by one or more business entities (or in some cases, by a partner of a business entity that processes transactions on behalf of business entities). Examples of businesses entities include merchant sites, resource information sites, utility sites, real estate management sites, social networking sites, etc., which offer various items for purchase and payment. In some embodiments, business entities may need registration of the user identity information as part of offering the items to the user 202 over the network 260. As such, each of the one or more merchant servers 230 may include a merchant database 232 for identifying available items, which may be made available to the user device 220 for viewing and purchase by the user 202. In one or more embodiments, user 202 may complete a transaction such as purchasing the items via service provider server 280.

Each of the merchant servers 230, in one embodiment, may include a marketplace application 234, which may be configured to provide information over the network 260 to the user interface application 222 of the user device 220. For example, user 202 may interact with the marketplace application 234 through the user interface application 222 over the network 260 to search and view various items available for purchase in the merchant database 232.

Each of the merchant servers 230, in one embodiment, may include at least one merchant identifier 236, which may be included as part of the one or more items made available for purchase so that, e.g., particular items are associated with particular merchants. In one implementation, the merchant identifier 236 may include one or more attributes and/or parameters related to the merchant, such as business and banking information. In various embodiments, user 202 may conduct transactions (e.g., searching, selection, monitoring, purchasing, and/or providing payment for items) with each merchant server 230 via the service provider server 280 over the network 260.

A merchant website may also communicate (for example, using merchant server 230) with the service provider through service provider server 280 over network 260. For example, the merchant website may communicate with the service provider in the course of various services offered by the service provider to merchant website, such as payment intermediary between customers of the merchant website and the merchant website itself. For example, the merchant website may use an application programming interface (API) that allows it to offer sale of goods in which customers are allowed to make payment through the service provider, while user 202 may have an account with the service provider that allows user 202 to use the service provider for making payments to merchants that allow use of authentication, authorization, and payment services of service provider as a payment intermediary. The merchant website may also have an account with the service provider.

The service provider server 280, in one embodiment, may be maintained by a transaction processing entity, which may provide processing for financial transactions and/or information transactions between the user 202 and one or more of the merchant servers 230. As such, the service provider server 280 includes a service application 282, which may be adapted to interact with the user device 220 and/or each merchant server 230 over the network 260 to facilitate the searching, selection, purchase, and/or payment of items by the user 202 from one or more of the merchant servers 230. In one example, the service provider server 280 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service application 282, in one embodiment, utilizes a payment processing module 284 to process purchases and/or payments for financial transactions between the user 202 and each of the merchant servers 230. In one implementation, the payment processing module 284 assists with resolving financial transactions through validation, delivery, and settlement. As such, the service application 282 in conjunction with the payment processing module 284 settles indebtedness between the user 202 and each of the merchants 230, wherein accounts may be directly and/or automatically debited and/or credited of monetary funds in a manner as accepted by the banking industry.

The service provider server 280, in one embodiment, may be configured to maintain one or more user accounts and merchant accounts in an account database 286, each of which may include account information 288 associated with one or more individual users (e.g., user 202) and merchants (e.g., one or more merchants associated with merchant servers 230). For example, account information 288 may include private financial information of user 202 and each merchant associated with the one or more merchant servers 230, such as one or more account numbers, passwords, credit card information, banking information, or other types of financial information, which may be used to facilitate financial transactions between user 202, and the one or more merchants associated with the merchant servers 230. In various aspects, the methods and systems described herein may be modified to accommodate users and/or merchants that may or may not be associated with at least one existing user account and/or merchant account, respectively.

In one implementation, the user 202 may have identity attributes stored with the service provider server 280, and user 202 may have credentials to authenticate or verify identity with the service provider server 280. User attributes may include personal information, banking information and/or funding sources as previously described. In various aspects, the user attributes may be passed to the service provider server 280 as part of a login, search, selection, purchase, and/or payment request, and the user attributes may be utilized by the service provider server 280 to associate user 202 with one or more particular user accounts maintained by the service provider server 280.

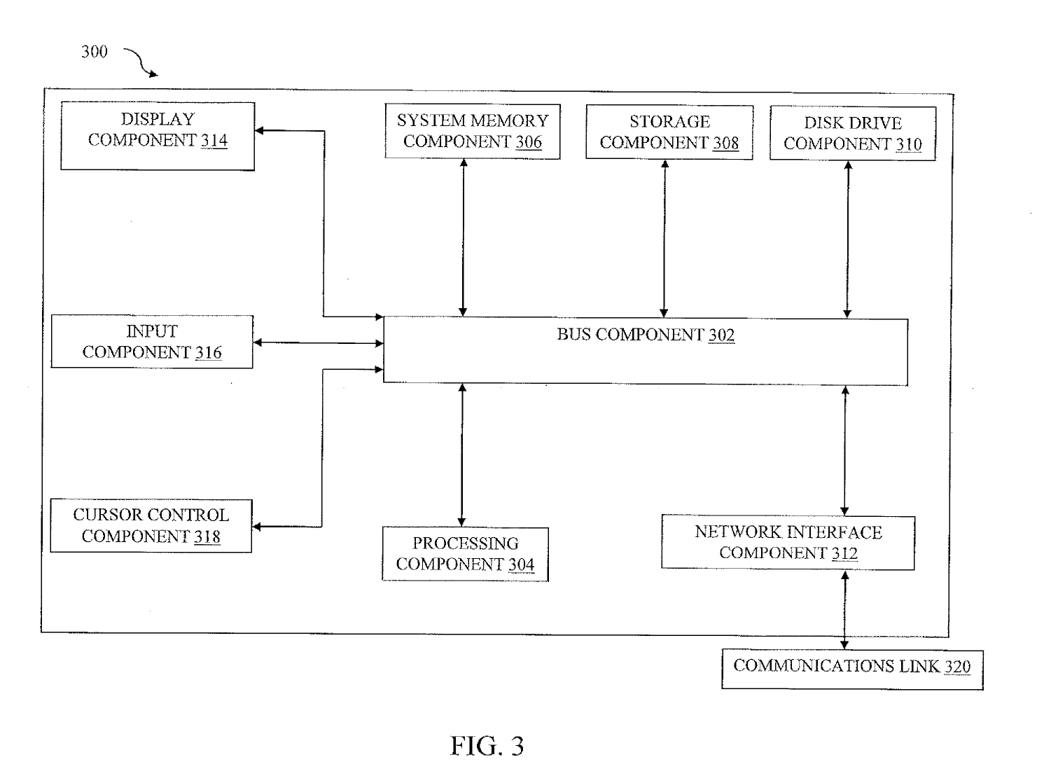

Referring now to FIG. 3, a block diagram of a system 300 is illustrated suitable for implementing embodiments of the present disclosure, including user device 220, one or more merchant servers or devices 230, and service provider server or device 280. System 300, such as part of a cell phone, a tablet, a personal computer and/or a network server, includes a bus 302 or other communication mechanism for communicating information, which interconnects subsystems and components, including one or more of a processing component 304 (e.g., processor, micro-controller, digital signal processor (DSP), etc.), a system memory component 306 (e.g., RAM), a static storage component 308 (e.g., ROM), a network interface component 312, a display component 314 (or alternatively, an interface to an external display), an input component 316 (e.g., keypad or keyboard), and a cursor control component 318 (e.g., a mouse pad).

In accordance with embodiments of the present disclosure, system 300 performs specific operations by processor 304 executing one or more sequences of one or more instructions contained in system memory component 306. Such instructions may be read into system memory component 306 from another computer readable medium, such as static storage component 308. These may include instructions to send and receive communications with links for tagged items, process financial transactions, make payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 304 for execution. Such a medium may take many forms, including but not limited to, non-volatile media, volatile media, and transmission media. In various implementations, volatile media includes dynamic memory, such as system memory component 306, and transmission media includes coaxial cables, copper wire, and fiber optics, including wires that comprise bus 302. Memory may be used to store visual representations of the different options for searching, auto-synchronizing, making payments or conducting financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 300. In various other embodiments, a plurality of systems 300 coupled by communication link 320 (e.g., network 260 of FIG. 2, LAN, WLAN, PTSN, or various other wired or wireless networks) may perform instruction sequences to practice the disclosure in coordination with one another. Computer system 300 may transmit and receive messages, data, information and instructions, including one or more programs (i.e., application code) through communication link 320 and communication interface 312. Received program code may be executed by processor 304 as received and/or stored in disk drive component 310 or some other non-volatile storage component for execution.

In view of the present disclosure, it will be appreciated that various methods and systems have been described according to one or more embodiments for facilitating payment using a user device.

Although various components and steps have been described herein as being associated with user device 220, merchant server 230, and service provider server 280 of FIG. 2, it is contemplated that the various aspects of such servers illustrated in FIG. 2 may be distributed among a plurality of servers, devices, and/or other entities.

Where applicable, various embodiments provided by the present disclosure may be implemented using hardware, software, or combinations of hardware and software, Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure. For example, although financial transactions have been described according to one or more embodiments, it should be understood that the present disclosure may also apply to transactions where requests for information, requests for access, or requests to perform certain other transactions may be involved.

Having thus described embodiments of the disclosure, persons of ordinary skill in the art will recognize that changes may be made in form and detail without departing from the scope of the disclosure. Thus the disclosure is limited only by the claims.

What is claimed is:

1. A system, comprising:
a memory device storing user account information, wherein the user account information comprises a device identifier (ID) associated with a user account; and
one or more processors in communication with the memory device and operable to:
collect identifying information regarding a user device;
create a device identifier (ID) based on the identifying information;
generate a session key that is associated with a transaction;
associate the session key with the device ID;
store the session key with the device ID;
receive the session key from a merchant;
retrieve the device ID;
determine a number of users associated with the device ID; and
based on the number, assess a risk of fraud for the transaction.

2. The system of claim 1, wherein the identifying information comprises at least one of an IP address, a local time, a local time zone, a browser user-agent, and a font type.

3. The system of claim 1, wherein the one or more processors is further operable to cause the device ID to be stored on the user device as persistent data.

4. The system of claim 3, wherein the persistent data comprises a cookie or information that is secured against alteration.

5. The system of claim 1, wherein the one or more processors is further operable to reject the transaction if the number of users associated with the device ID exceeds a predetermined number.

6. The system of claim 5, wherein the predetermined number is 3 or more users.

7. The system of claim 1, wherein the one or more processors is further operable to restrict the scope of the transaction if the number of users associated with the device ID exceeds a predetermined number.

8. The system of claim 1, wherein the transaction comprises purchase amount, transfer amount, type of transfer requested, item or service purchased, or a combination thereof

9. A method for detecting fraud, comprising:
collecting, by one or more hardware processors of a service provider, identifying information regarding a user device;
creating a device identifier (ID) based on the identifying information;
generating a session key that is associated with a transaction;
associating the session key with the device ID;
storing the session key with the device ID;
receiving the session key from a merchant;
retrieving the device ID;
determining a number of users associated with the device ID; and
based on the number, assessing a risk of fraud for the transaction.

10. The method of claim 9, wherein the identifying information comprises at least one of an IP address, a local time, a local time zone, a browser user-agent, and a font type.

11. The method of claim 9, further comprising causing the device ID to be stored on the user device as persistent data.

12. The method of claim 11, wherein the persistent data comprises a cookie or information that is secured against alteration.

13. The method of claim 9, further comprising rejecting the specific transaction if the number of users associated with the device ID exceeds a predetermined number.

14. The method of claim 13, wherein the predetermined number is 3 or more users.

15. The method of claim 9, further comprising restricting the scope of the transaction if the number of users associated with the device ID exceeds a predetermined number.

16. A non-transitory machine-readable medium comprising a plurality of machine-readable instructions which, when executed by one or more processors, are adapted to cause the one or more processors to perform a method comprising:
collecting identifying information regarding a user device;
creating a device identifier (ID) based on the identifying information;
generating a session key that is associated with a transaction;
associating the session key with the device ID;
storing the session key with the device ID;
receiving the session key from a merchant;
retrieving the device ID;
determining a number of users associated with the device ID; and
based on the number, assessing a risk of fraud for the transaction.

17. The non-transitory machine-readable medium of claim 16, wherein the identifying information comprises at least one of an IP addresses, a local time, a local time zone, a browser user-agent, and a font type.

18. The non-transitory machine-readable medium of claim 16, wherein the method further comprises causing the device ID to be stored on the user device as persistent data, and the persistent data comprises a cookie or information that is secured against alteration.

19. The non-transitory machine-readable medium of claim 16, wherein the method further comprises rejecting the transaction or limiting the scope of the transaction if the number of users associated with the device ID exceeds a predetermined number.

20. The non-transitory machine-readable medium of claim 19, wherein the predetermined number is 3 or more users.
